(19) United States
(12) Patent Application Publication
(10) Pub. No.: US 2016/0147940 A1
(43) Pub. Date: May 26, 2016

(54) COLLABORATIVE CLOUD-BASED SHARING OF MEDICAL IMAGING STUDIES WITH OR WITHOUT AUTOMATED REMOVAL OF PROTECTED HEALTH INFORMATION

(71) Applicant: Citrix Systems, Inc., Fort Lauderdale, FL (US)

(72) Inventor: Alexander Calhoun Flint, Menlo Park, CA (US)

(21) Appl. No.: 15/009,121

(22) Filed: Jan. 28, 2016

Related U.S. Application Data
(63) Continuation of application No. 13/829,133, filed on Mar. 14, 2013.
(60) Provisional application No. 61/618,520, filed on Mar. 30, 2012.

(51) Int. Cl. G06F 19/00; G06F 21/62

(52) U.S. Cl. CPC G06F 19/321; G06F 21/6245

(57) ABSTRACT

A technique manages medical image data. The technique involves receiving an original medical imaging study that includes a set of medical images and embedded protected patient information. The technique further involves performing a protected patient information removal operation which generates a cloud-storable medical imaging study from the original medical imaging study. The cloud-storable medical imaging study includes the set of medical images but omitting the embedded protected patient information. The technique further involves storing the cloud-storable medical imaging study in a cloud-based medical image repository among other cloud-storable medical image studies. The cloud-based medical image repository is external to the computerized device and public network accessible.

### CROSS-REFERENCE TO RELATED APPLICATIONS

This application is a continuation of U.S. application Ser. No. 13/829,133 which claims priority from U.S. Provisional No. 61/618,520, by Alexander Calhoun Flint, titled “Cloud-based sharing of medical imaging studies without protected health information,” which was filed Mar. 30, 2012, and which is hereby incorporated by reference.

### BACKGROUND

1. Field of the Invention

This invention relates to electronic storage and exchange of medical imaging study computer files. Generally, this invention relates to sharing of medical imaging studies over networks and network-enabled devices after Identifiable Imaging Studies that cannot legally be shared have been transformed into Cleared Imaging Studies that can be legally, and securely, shared.

2. Description of Related Art

Medical imaging studies are generated from a variety of sources, including roentgenography, computed tomography, magnetic resonance imaging, ultrasound, and nuclear medicine techniques. Most medical imaging is stored in digital form, using the Digital Imaging and Communications in Medicine (DICOM) storage and transfer protocol to combine originating systems, servers, and networked computers into a Picture Archiving and Communications System (PACS).

Medical imaging files include embedded DICOM metadata in computer-readable binary form to store identifying information about the patient and the study. A specific subset of these metadata comprise patient-identifying information fields that constitute Protected Health Information (PHI). In the DICOM standard, metadata are embedded into each DICOM image file as binary information together with other binary information encoding the digital image itself. In the DICOM standard, images are organized in several ways, typically in groups of images known as series and groups of series known as studies. Each image thus organized is typically represented by an individual binary file containing image data and binary header information comprising metadata containing PHI and metadata not containing PHI. As each image file typically contains hundreds of binary metadata fields and a DICOM study contains hundreds or even thousands of files, stored DICOM binary metadata and DICOM image information are necessarily inseparable by human mental effort without the aid of computer processing.

When it is desirable to transfer images from one center with a PACS or DICOM server or from portable digital media to a different center or remote digital storage system (for example, a different PACS or DICOM server), transmission and storage of associated PHI raises important patient privacy concerns.

In the general art, PHI is recognized to be any personal information, stored in association with health-related records, that could be used to identify the individual that the health-related records belong to. Specific criteria for defining PHI are further provided in the U.S. federal law known as HIPAA (the U.S. Health Insurance Portability and Accountability Act of 1996, Pub.L. 104-191, 110 Stat. 1936, enacted Aug. 21, 1996), which enumerates 18 identifiers associated with medical information that are considered PHI if they identify an individual, his/her relatives, his/her employers, or his/her household members.

Sharing, disclosing, or transmitting medical information with associated PHI requires the explicit granting of permission to share such information by the patient or his/her legal representative.

Within a single medical center, office, hospital, or other organization, medical imaging files can generally be accessed by appropriately credentialed users of a single PACS system without inappropriate disclosure of PHI. However, in circumstances wherein it is desirable to share medical imaging studies across different medical centers, offices, hospitals, or other organizations, such as when outside consultation is needed or time-critical emergency transfers must be arranged to an appropriate level of care, it has not been possible to share medical imaging studies in a flexible yet secure fashion that avoids inappropriate disclosure of PHI.

Ge, et al., U.S. patent application Ser. No. 12/827,717 describe a central key server technique for granting of permissions to specific healthcare facilities to access their remotely stored medical information. The method described in Ge, et al., requires the patient to provide explicit a priori organizational-level permission for information sharing by healthcare entities to take place. Sharing of data under emergency conditions, in which the patient may not have capacity to provide a priori permissions, and sharing of medical information directly from patient to doctor are not taught by Ge, et al.

Vesper, et al., U.S. patent application Ser. No. 12/968,657 and Ser. No. 12/971,302, describe a method for the separate storage of personal information and non-personal information related to medical imaging studies and a schema by which the personal information and non-personal information are re-joined at the time of medical image viewing. In the method taught by Vesper, et al., data tables are configured such that data containing PHI is easily re-joined to medical imaging data at the time of medical image viewing and therefore sharing and viewing of medical imaging studies with associated PHI can occur without appropriate granting of patient permission to share or disclose PHI.

When medical imaging studies are shared by means of computers or devices and transmitted over networks, it is critical to the provision of clinical care that medical images are not altered or degraded in quality. Methods available in the current art fail to allow for simultaneous viewing of medical images by multiple parties between multiple networked devices without the substantial risk of image degradation that is inherent to bandwidth-limited technologies such as web video screen sharing.

### SUMMARY

Generally, in various embodiments, the present invention is a system for cloud-based storage of, sharing of, and collaboration over medical imaging studies from which protected health information (PHI) metadata are removed by means of automated computer processing when it is advantageous to remove such information and, in other embodiments, PHI metadata are retained with the medical imaging studies, specifically when the medical imaging studies are derived from the individual user of the cloud-based medical imaging system.

In embodiments of one general aspect of the invention, a healthcare professional or other user employs software, a cloud-based medical image repository, and cloud-based medical image viewing software to store, view, and share medical imaging studies in a cloud-based medical image system with selective and automated removal by computer algorithm of binary metadata containing PHI. With medical imaging studies without PHI uploaded to the cloud-based medical image repository, the user securely shares access to the medical imaging studies with other users of the cloud-based medical image repository, with one or more parties using cloud-based medical image viewing software to view the medical imaging studies, either independently or in collaborative fashion, simultaneously, from multiple different network-enabled devices. Studies uploaded in these embodiments of the invention to the cloud-based medical imaging repository are referred to as Cleared Imaging Studies Without PHI.

In embodiments of another general aspect of the invention, the user of the software, cloud-based medical image repository, and cloud-based medical image viewing software is the individual from whom the medical imaging studies have been derived, or is the legal representative of said individual. In various embodiments of this general aspect of the invention, the patient (or patient's legal representative) provides explicit consent (such as a “HIPAA waiver”) to use the cloud-based medical image repository in order to store, securely share, and view their personal medical imaging studies with retention of metadata containing PHI. Studies uploaded in these embodiments of the invention to the cloud-based medical imaging repository are referred to as Cleared Imaging Studies With PHI.

In various embodiments of the invention, users of the cloud-based medical imaging repository may be granted secure access to view medical imaging studies of either type (Cleared Imaging Studies Without PHI or Cleared Imaging Studies With PHI) by the user designated to be the Study Owner in the cloud-based medical image repository.

In various embodiments of the invention, one or more users access and view medical imaging studies in the cloud-based medical image repository using cloud-based medical image viewing software. When two or more users access and view a medical imaging study in the cloud-based medical image repository from multiple network-enabled devices (such as computers, tablets, phones, or other devices), various embodiments of the invention provide for transmission of medical images to local caches in each device without degradation or alteration of the medical images, with separate exchange of additional data to facilitate shared study viewing and collaboration. With the appropriate set of medical images stored locally in each device for collaborative viewing, additional data streams comprising image window width and level, image pan, and image zoom are transmitted among the devices by means of network connection with the cloud-based imaging system. In various embodiments, the cloud-based medical image system provides for exchange of cursor position, user-derived non-destructive markups and measurements, and additional data streams comprising text, video, and audio wherein these data streams are shared among the devices independent of the transmission of medical image data.

In various embodiments, one or more users access and view medical imaging studies in the cloud-based medical image repository using cloud-based medical image viewing software known as a “web application” that is displayed using web browser software on a networked device such as a computer, tablet device, cellular phone, or other device. In alternate embodiments, one or more users access and view medical imaging studies in the cloud-based medical image repository using native software on a networked device such as a computer, tablet device, cellular phone, or other device that interacts with the cloud-based medical image repository by means of the internet or other network.

In various embodiments of the invention, the designated Study Owner is provided with additional data entry fields and means to enter data into such fields in order to add annotations, comments, tags, or other information to organize one or more studies in the cloud-based medical image repository. In Cleared Imaging Studies Without PHI in various embodiments of the invention, the user designated as Study Owner is prompted by the cloud-based medical image system to provide electronic agreement indicating that they will not enter any patient-identifying information into any additional data entry fields.

In various embodiments of the invention, image data are stored in the original DICOM format after appropriate processing to remove PHI-containing metadata in embodiments where this is desired. In alternate embodiments, image data are stored in another standard image file format, such as the Portable Network Graphics (PNG) format or the Joint Photographic Experts Group (JPEG) format. In various embodiments, metadata information is stored together with each image file in the cloud-based medical image repository. In alternate embodiments, metadata information is stored in a separate data table that is linked to the image file or files.

In alternate embodiments of the invention, the software is configured to be able to interact by means of network connection with the cloud-based medical image repository to exchange digital information such as a digital receipt that includes the randomly generated Study Code assigned to a medical imaging study in the cloud-based medical image repository and software to provide for two-way communication regarding a particular medical imaging study, including, but not limited to, reports, impressions, comments, or other annotations made by a user or users employing the cloud-based medical image repository or cloud-based medical image viewing software. In various embodiments of the invention, the software is configured to retain, by secure storage on local media, the randomly generated Study Code corresponding to a medical imaging study in association with metadata containing PHI related to the medical imaging study.

The present invention is not intended to be limited to a device or method which must satisfy one or more of any stated or implied objects or features of the invention. The present invention is not limited to the preferred, exemplary, or primary embodiment or embodiments described herein. Modifications and substitutions by one of ordinary skill in the art are considered to be within the scope of the present invention, which is not to be limited except by the following claims.

The systems and methods may be provided on many different types of computer-readable media including computer storage mechanisms (e.g., CD-ROM, diskette, RAM, flash memory, computer hard drive, etc.) that contain instructions for use in execution by a processor to perform the methods' operations and implement the systems described herein.

With respect to the appended claims, unless stated otherwise, the term “first” does not, by itself, require that there also be a “second”. Moreover, reference to only “a first” and “a second” does not exclude additional items. While the particular computer-based systems and methods described herein and described in detail are fully capable of attaining the above-described objects and advantages of the invention, it is to be understood that these are the presently preferred embodiments of the invention and are thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “one or more” and not “one and only one”, unless otherwise so recited in the claim.

Although the invention has been described relative to specific embodiments thereof, there are numerous variations and modifications that will be readily apparent to those skilled in the art in light of the above teachings. It is therefore to be understood that, within the scope of the appended claims, the invention may be practiced other than as specifically described.

One embodiment is directed a method for accessing and transforming medical imaging studies that cannot be shared legally with Third Parties into medical imaging studies that can be shared legally and securely with Third Parties.

In some arrangements, the medical imaging studies that cannot be shared legally with Third Parties are Identifiable Imaging Study files.

In some arrangements, the medical imaging studies that can be shared legally and securely with Third Parties are Cleared Imaging Study files.

In some arrangements, the access or transformation employs software resident on a computer local to a user.

In some arrangements, the access or transformation employs networked devices to upload, transmit, download, store, view, annotate, or otherwise use the studies.

Another embodiment is directed to an automated method for transforming one or more Identifiable Imaging Studies into one or more Cleared Imaging Studies Without PHI to transfer the studies, legally and securely, from a user to one or more Third Parties. The method includes receiving a request from the user to transfer the one or more medical imaging studies to the one or more Third Parties, performing automated removal of AM+PHI from the one or more Identifiable Imaging Studies to generate one or more Cleared Imaging Studies Without PHI, and transmitting the one or more Cleared Imaging Studies Without PHI to the one or more Third Parties.

In some arrangements, the method further includes generating a unique identification for the one or more Cleared Imaging Study files.

In some arrangements, such unique identification is associated with the one or more Cleared Imaging Study files.

In some arrangements, the user is a healthcare provider or healthcare researcher.

In some arrangements, the one or more Third Parties are healthcare providers or healthcare researchers.

In some arrangements, the user is the Patient from whom the one or more medical imaging study files are derived.

In some arrangements, two or more users of network-enabled devices view medical imaging studies simultaneously. Here, one or more medical images are transmitted to each user's device from one or more networked servers and cached in each user's device, and additional data streams are exchanged between devices by network connections to one or more networked servers to communicate additional data to support image viewing.

In some arrangements, the one or more medical images are transmitted to each user's device from one or more networked servers and cached in each user's device in unaltered form.

In some arrangements, the one or more medical images are subjected to image compression and then transmitted to each user's device from one or more networked servers and cached in each user's device.

In some arrangements, the additional data supports image viewing, or the transmission of audio, video, or textual communication streams, whether or not the data or streams affect a durable alteration to the medical image file.

In some arrangements, the method further includes allowing one or more users accessing the Cleared Imaging Studies to enter data in the form of database entries, annotations, comments, tags, or other information to organize one or more studies in a medical image repository.

In some arrangements, the user accessing the medical image studies is required to provide electronic agreement that they will not enter any patient-identifying information into such data entry fields.

Another embodiment is directed to an automated method for transforming one or more Identifiable Imaging Studies associated with a Patient into one or more Cleared Imaging Studies With PHI to transfer the studies from the Patient to one or more Third Parties. The method includes receiving a request from the Patient to transfer the one or more Identifiable Imaging Studies to the one or more other users, verifying that the one or more Identifiable Imaging Studies are of the Patient, verifying that the Patient has signed or otherwise provided an effective waiver, and transmitting the one or more Cleared Imaging Studies With PHI to the one or more Third Parties.

In some arrangements, an effective waiver is a HIPAA Waiver.

In some arrangements, a Patient's Legal Representative is provided with means to act on behalf of the Patient.

In some arrangements, the one or more Third Parties are healthcare providers or healthcare researchers.

In some arrangements, two or more users of network-enabled devices view medical imaging studies simultaneously. Here, one or more medical images are transmitted to each user's device from one or more networked servers and cached in each user's device, and additional data streams are exchanged between devices by means of network connections to one or more networked servers to communicate additional data to support image viewing.

In some arrangements, the one or more medical images are transmitted to each user's device from one or more networked servers and cached in each user's device in unaltered form.

In some arrangements, the one or more medical images are subjected to image compression and then transmitted to each user's device from one or more networked servers and cached in each user's device.

In some arrangements, the additional data supports image viewing, or the transmission of audio, video, or textual communication streams, whether or not the data or streams affect a durable alteration to the medical image file.

### BRIEF DESCRIPTION OF THE DRAWINGS

The invention will be hereafter described with reference to the drawings, where:

FIG. 1 is a diagrammatic sketch showing the system of transfer of medical imaging studies to a cloud-based image repository, wherein images and metadata lacking protected health information (PHI) are received and stored in the account of a medical professional in the cloud-based image repository, and metadata containing PHI are excluded by computer-automated means.

FIG. 2 is a diagrammatic sketch showing the system of transfer of medical imaging studies from a patient's personal computer to a cloud-based image repository, wherein images, metadata lacking PHI, and metadata containing PHI are received and stored in the patient's account in the cloud-based image repository.

FIG. 3 is a diagrammatic sketch showing the system of transfer of medical imaging studies belonging to a patient from a medical facility originating the medical imaging studies to the same patient's account in a cloud-based image repository, wherein images, metadata lacking PHI, and metadata containing PHI are received and stored in the cloud-based image repository.

FIG. 4 is a diagrammatic sketch showing the system by which medical imaging studies are processed according to whether or not the studies belong to the user, illustrating the computer-automated steps followed in each case and the sharing of the two types of studies with another account.

FIG. 5 is diagrammatic sketch showing the system of simultaneous medical image viewing among several parties using various internet-enabled devices, wherein all parties view locally cached medical images and separately exchange additional data to facilitate shared study viewing and collaboration.

### DETAILED DESCRIPTION

### Abbreviations and Definitions

Patient: The individual subject of a given medical imaging study.

Patient's Legal Representative: An individual with legal standing to represent a patient and provide consent on a patient's behalf.

Care Provider: a medical professional involved in Patient's care.

Third Party: Anyone other than the Patient, a Patient's Legal Representative, or a Care Provider. A Third Party may be another healthcare professional.

PHI: Protected Health Information, defined generally in the art as information associated with health-related data, such as medical imaging studies, that could enable a Third Party to identify the Patient represented in the health-related data, or said Patient's relatives, employers, or household members.

AM: Associated Metadata, the metadata associated with a given medical imaging study. All medical imaging studies contain two distinct (possibly null) sets of AM:

AM+PHI: AM that contains PHI; and

AM/PHI: AM that does not contain PHI.

Identifiable Imaging Study: A medical imaging study containing AM+PHI.

Cleared Imaging Study: A medical imaging study that may be legally shared with a Third Party. Cleared imaging studies include:

Cleared Imaging Study Without PHI: the imaging study has had all AM+PHI removed; or

Cleared Imaging Study With PHI: the Patient represented in the medical imaging study has signed or otherwise provided a HIPAA waiver for the purpose of transferring their medical images to designated Third Parties.

PACS: Picture Archiving and Communications System, a system known in the art for local storage and local network communication of medical imaging studies.

DICOM: Digital Imaging and Communications in Medicine, a file format and file transfer protocol known in the art for the exchange of digital medical imaging studies with AM.

HIPAA: The U.S. Health Insurance Portability and Accountability Act of 1996, Pub.L. 104-191, 110 Stat. 1936, enacted Aug. 21, 1996, and any subsequent amendments as may arise from time to time.

Effective Waiver—Legal authorization to share or communicate information regarding a Patient.

HIPAA Waiver—An effective waiver as spelled out under HIPAA.

In various embodiments, the present invention is a method for accessing and transforming medical imaging studies that cannot be shared legally with Third Parties into medical imaging studies that can be shared legally and securely with Third Parties. In various embodiments, the invention provides receiving by a computer a request from a user to share medical imaging studies, determining whether one or more rules associated with said sharing apply to the request from the user, processing the request if all rules determined to be applicable are satisfied, and denying the request if one or more rules determined to be applicable are not satisfied, wherein said processing comprises transforming said medical imaging studies that cannot be shared legally with Third Parties into medical imaging studies that can be shared legally and securely with Third Parties. In various embodiments, the invention provides a computer-based system capable of accessing and transforming medical imaging studies, said system comprising a processor coupled to a memory, the memory having computer readable code, which when executed by the processor causes the computer system to perform the method for accessing and transforming medical imaging studies that cannot be shared legally with Third Parties into medical imaging studies that can be shared legally and securely with Third Parties.

In preferred embodiments, a method is provided for electronic transmission, storage, and sharing of medical imaging studies, facilitating secure sharing of medical imaging studies by care providers or patients, wherein Care Provider, Patient, or Patient's Legal Representative is provided with computer network-based transmission, storage, and sharing of Cleared Medical Imaging Studies wherein one or more Third Parties are provided with cloud-based viewing of medical imaging studies after care provider or patient grants permission to share medical imaging studies in a cloud-based system for transmission, storage, and sharing of medical imaging studies, and multiple Third Parties with granted viewing permissions are provided with viewing, simultaneously or independently, of medical imaging studies in the cloud-based system for transmission, storage, and sharing of medical imaging studies with the capability to exchange information regarding medical imaging studies over data streams not used for transmission of medical images.

In various embodiments, a method for accessing and transforming medical imaging studies that cannot be shared legally with Third Parties into medical imaging studies that can be shared legally and securely with Third Parties is provided wherein medical imaging studies that cannot be shared legally with Third Parties are Identifiable Imaging Study files. In various embodiments, medical imaging studies that can be shared legally and securely with Third Parties are Cleared Imaging Study files. In various embodiments, access to medical imaging studies or transformation of medical imaging studies employs software resident on a computer local to a user. In preferred embodiments, said access to medical imaging studies or transformation of medical imaging studies employs networked devices to upload, transmit, download, store, view, annotate, or otherwise use the studies.

In various embodiments, the invention provides an automated method for transforming one or more Identifiable Imaging Studies into one or more Cleared Imaging Studies Without PHI to transfer said studies, legally and securely, from a user to one or more Third Parties. Said automated method comprises receiving a request from said user to transfer said one or more medical imaging studies to said one or more Third Parties, performing automated removal of AM+PHI from said one or more Identifiable Imaging Studies to generate one or more Cleared Imaging Studies Without PHI, and transmitting said one or more Cleared Imaging Studies Without PHI to said one or more Third Parties.

In various embodiments, a method is provided wherein a Care Provider or other user is provided with cloud-based transmission, storage, and sharing of medical imaging studies with AM/PHI but without AM+PHI. In said method, software installed locally on Care Provider or other user's facility or computer possesses capability to receive Identifiable Imaging Studies from a network, storage media or other means of electronic communication. Said method provides for automatic and selective removal of AM+PHI, selective retention of AM/PHI, generating Cleared Imaging Studies Without PHI. Said method provides for transmission of Cleared Imaging Studies Without PHI to a cloud-based service for the purpose of transmission, storage, and sharing of medical imaging studies. In various embodiments, said method further comprises generating a unique identification for said one or more Cleared Imaging Study files. In various embodiments, said unique identification is associated with said one or more Cleared Imaging Study files. In various embodiments, said Care Provider or other user is a healthcare provider or healthcare researcher. In various embodiments, said user is the Patient from whom said one or more medical imaging study files are derived. In various embodiments, said one or more Third Parties are healthcare providers or healthcare researchers.

In preferred embodiments, said one or more medical images are transmitted to each user's device from one or more networked servers and cached in each user's device in unaltered form. In alternate embodiments, said one or more medical images are subjected to image compression and then transmitted to each user's device from one or more networked servers and cached in each user's device.

In various embodiments, one or more users accessing Cleared Imaging Studies are provided capability to enter data in the form of database entries, annotations, comments, tags, or other information to organize one or more studies in a medical image repository. In preferred embodiments, one or more users accessing Cleared Imaging Studies are required to provide electronic agreement that they will not enter any patient-identifying information into such data entry fields.

In various embodiments, an automated method is provided for transforming one or more Identifiable Imaging Studies associated with a Patient into one or more Cleared Imaging Studies With PHI to transfer said studies from said Patient to one or more Third Parties, said method comprising receiving a request from said Patient to transfer said one or more Identifiable Imaging Studies to said one or more other users, verifying that said one or more Identifiable Imaging Studies are of said Patient, verifying that said Patient has signed or otherwise provided an effective waiver, such as a HIPAA Waiver, and transmitting said one or more Cleared Imaging Studies With PHI to said one or more Third Parties. In other embodiments, Patient's Legal Representative is provided with means to act on behalf of said Patient to transform one or more Identifiable Imaging Studies associated with a Patient into one or more Cleared Imaging Studies With PHI to transfer said studies from said Patient to one or more Third Parties. In preferred embodiments, said Third Parties are healthcare providers or healthcare researchers.

In various embodiments, Patient or Patient's Legal Representative is provided with transmission, storage, and sharing of medical imaging studies with AM+PHI by means of local software, installed on patient's computer or device, with capability to receive medical imaging studies and associated metadata from storage media, verify that said medical imaging studies belong to the Patient and that the Patient or Patient's Legal Representative has electronically provided consent to use the cloud-based service for the purpose of transmission, storage, and sharing of medical imaging studies with AM+PHI, and transmit Cleared Imaging Studies With PHI to a cloud-based service for the purpose of transmission, storage, and sharing of medical imaging studies.

In various embodiments, Patient or Patient's Legal Representative is provided with transmission, storage, and sharing of medical imaging studies with AM+PHI, by means of local software, installed at a medical facility, with capability to receive medical imaging studies and associated metadata from a network or storage media, verify that Patient or Patient's Legal Representative has electronically provided consent to use the cloud-based service for the purpose of transmission, storage, and sharing of medical imaging studies with AM+PHI, and transmit medical imaging studies with AM+PHI to a cloud-based service for the purpose of transmission, storage, and sharing of medical imaging studies.

In various embodiments, one or more users of network-enabled devices who have been granted viewing access permissions by a Care Provider, Patient, or Patient's Legal Representative are provided with cloud-based medical image viewing of one or more Cleared Imaging Studies in the cloud-based system for transmission, storage, and sharing of medical imaging studies.

In various embodiments, a method is provided wherein two or more users of network-enabled devices view Cleared Imaging Studies simultaneously, and one or more medical images are transmitted to each user's device from one or more networked servers and cached in each user's device, and additional data streams are exchanged between devices by network connections to one or more networked servers to communicate additional data to support image viewing. In various embodiments, said additional data to support image viewing provides transmission of audio, video, or textual communication streams. In various embodiments, said additional data to support image viewing comprises variables specifying current image to be viewed, image position, image zoom, window width and level, image brightness and contrast, position of user-controlled cursors, position of user-controlled reference lines, position of user-controlled regions of interest, user-determined image-derived measurements, number of images to be simultaneously viewed, and image position and location references between images being viewed simultaneously. In various embodiments, said additional data to support image viewing provides for user-initiated and user-controlled adjustments to medical image appearance that affect display parameters without durably altering the medical image. In various embodiments, additional data to support image viewing comprises transmission of audio, video, and text communication data streams that support real-time collaboration between users viewing medical imaging studies.

The invention will now be described in further detail by reference to the drawings, which illustrate alternative embodiments of the invention. The drawings are diagrammatic, showing features of the invention and their relation to other features and structures, and are not made to scale. For improved clarity of presentation, in the FIGS. illustrating embodiments of the invention, features corresponding to features shown in other drawings are not all particularly renumbered, although they are all readily identifiable in all the FIGS.

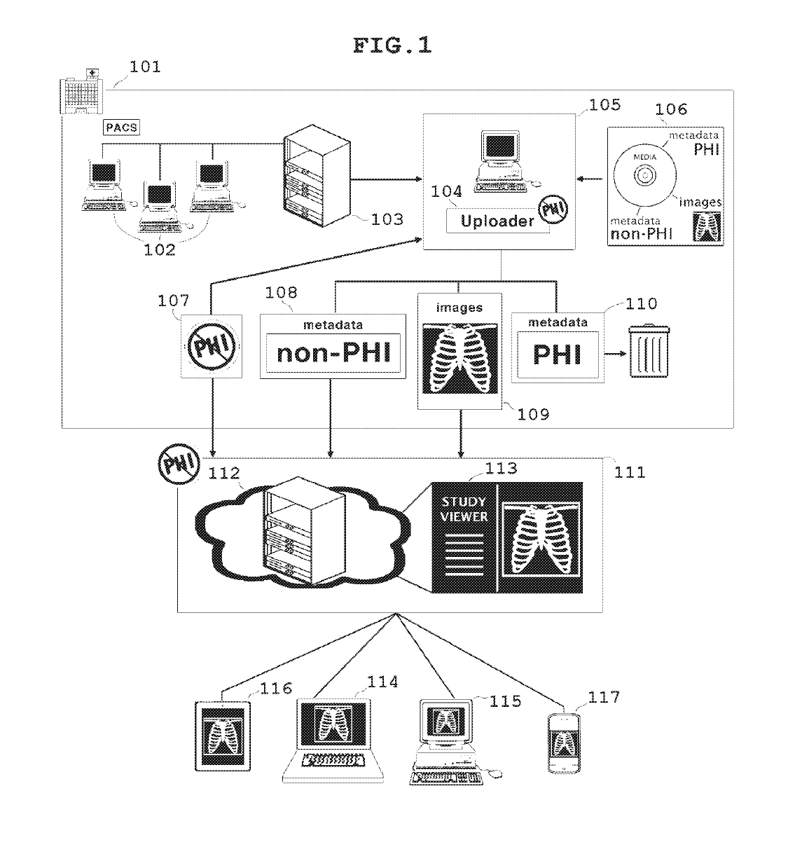

In various embodiments shown in FIG. 1, medical imaging studies are stored behind the firewall of a hospital, imaging center, or other medical facility 101 on various computers 102 and servers 103 networked together to form a PACS. On one or more computers 105 networked to the PACS servers 103 behind the facility firewall 101, a software program 104 is installed with capabilities for automated extraction by computer algorithm of medical images 109, AM/PHI 108, and AM+PHI 110.

In these embodiments, medical images, AM/PHI, and AM+PHI are transmitted to the software program 104 electronically by means of digital media 106 or electronically from computers on a local network 102 or server 103 or other transmission system behind the facility firewall by means of DICOM protocol transmission or by means of another electronic communications protocol for transmission of medical imaging studies.

By means of a secure two-way network communication 107, a software program 104 behind the facility firewall 101 algorithmically determines that the receiving account in a cloud-based medical image repository 111 is capable and appropriately credentialed to receive medical imaging studies 109 together with AM/PHI 108, but without AM+PHI 110. Medical imaging studies 109 together with AM/PHI 108, but without AM+PHI 110, are then transmitted electronically over the Internet or another electronic networking system to cloud computing servers 112 supporting a cloud-based medical image repository 111. Accordingly, in these embodiments, no metadata containing PHI 110 is transmitted outside of the facility firewall 101.

In various embodiments, specific AM+PHI 110 fields are used, by means of automated computer algorithm, to generate specific AM/PHI 108 fields prior to transmission outside of the facility firewall. For example, DICOM metadata fields encoding, in binary form, the birth date of the patient and the date of the study performance are processed to determine current age of the patient at the time of the study, and if age is 89 or less, the computer algorithm stores that resulting value as the patient's age, but if the age is order than 89 years of age, “90 or older” is stored and subsequently transmitted as the patient's age.

In various embodiments shown in FIG. 1, viewing and sharing of medical imaging studies 109 together with AM/PHI 108, but without AM+PHI 110, is performed by means of cloud medical image viewing and sharing software 113 that may be accessed simultaneously or independently by web-browser software or other local software on one or more devices with internet access, for instance, laptop computers 114, desktop computers 115, tablet computer 116, smartphones 117, or other internet-enabled appliances.

In various embodiments shown in FIG. 1, access to view medical imaging studies 109 together with AM/PHI 108, but without AM+PHI 110, is established by electronic permissions exchanged between users of the system by means of interface with the cloud medical image viewing and sharing software 113 from one or more devices with internet access, for instance, laptop computers 114, desktop computers 115, tablet computers 116, smartphones 117, or other internet-enabled appliances, wherein a single user is designated the controlling entity or study owner and exerts control electronically over designation of sharing and viewing permissions.

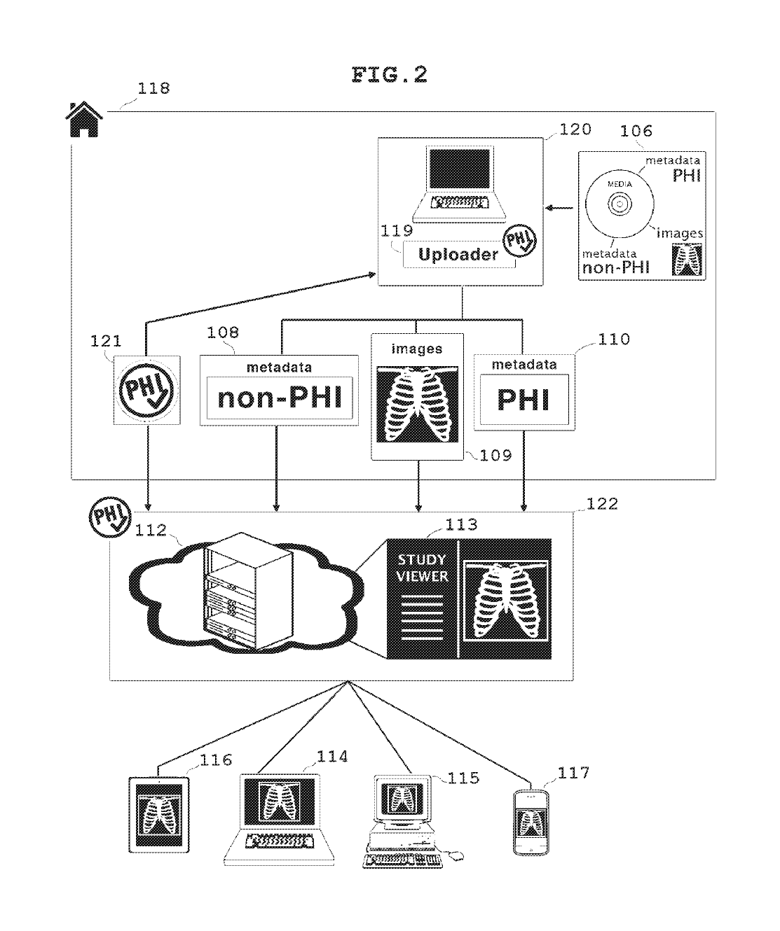

In various embodiments shown in FIG. 2, a patient or legal representative in possession of digital media 106 containing said patient's medical imaging studies uses a software program 119 configured to process and transmit medical imaging studies together with AM/PHI and AM+PHI that is installed on a personal computer 120 or other computing device networked by means of the Internet or another communications system to cloud computing servers 112 supporting a cloud-based medical image repository 122. In these embodiments, wherein it is advantageous for a patient or their legal representative to retain all metadata associated with their personal medical imaging studies, the patient or legal representative uses embodiments of the software program specifically configured to process all metadata (AM/PHI 108 and AM+PHI 110) and medical images from the source media 106 and the patient or legal representative provides specific legal consent to use the software program 119 and their account in the cloud-based medical image repository 122 to retain AM+PHI 110 in association with their medical imaging studies 109.

In embodiments illustrated in FIG. 2, the software program 119 installed on the patient or legal representative's personal computer 120 algorithmically determines, by means of a secure two-way network communication 121, that the receiving account in the cloud-based medical image repository 122 is capable and appropriately credentialed to receive medical imaging studies 109 together with AM/PHI 108 and AM+PHI 110. Medical imaging studies 109 together with AM/PHI 108 and AM+PHI 110 are then transmitted electronically over a secure network connection to the appropriately credentialed receiving account in the cloud-based medical imaging repository 122, supported on cloud computing servers 112. Accordingly, in various embodiments, such as illustrated in FIG. 2, AM+PHI 110 is transmitted to the cloud after Patient or Patient's Legal Representative provides legal consent to transmit said Patient's AM+PHI 110 in association with said Patient's medical imaging studies 109 and AM/PHI 108.

In various embodiments shown in FIG. 2, access to view medical imaging studies 109 together with AM/PHI 108 and AM+PHI 110, is established by electronic permissions exchanged between users of the system by means of interface with the cloud medical image viewing and sharing software 113 from one or more devices with internet access, for instance, laptop computers 114, desktop computers 115, tablet computers 116, smartphones 117, or other internet-enabled appliances, wherein Patient or Patient's Legal Representative is designated the controlling entity or study owner and exerts control electronically over designation of sharing and viewing permissions.

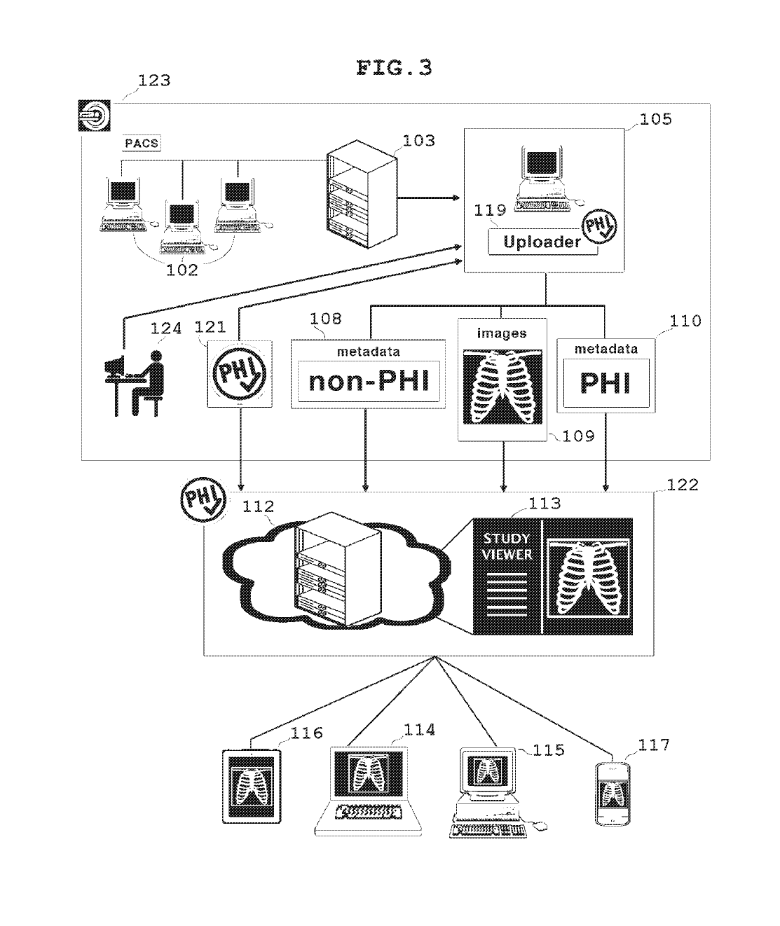

In various embodiments shown in FIG. 3, medical imaging studies stored on networked computers 102 or servers 103 within a PACS or similar medical image storage system within a facility 123 capable of performing and storing medical imaging studies are transmitted by DICOM or other medical imaging transfer protocol to a software program 119 installed on a computer 105 behind the firewall of medical imaging facility 123. In the embodiments shown in FIG. 3, the software program 119 installed on the imaging center computer 105 determines, by means of a secure two-way network communication 121, that the receiving account in the cloud-based medical image repository 122 is capable and appropriately credentialed to receive medical imaging studies 109 together with AM/PHI 108 and AM+PHI 110.

As shown in FIG. 3, a PACS administrator or other appropriately credentialed individual 124 verifies the identity of the patient and enters the patient's account name on the cloud-based medical imaging system 122 into the software program 119, enabling the software program 119 to transmit the medical imaging studies to the correct account in the cloud-based medical image repository 122. Medical imaging studies 109 together with AM/PHI 108 and AM+PHI 110 are then transmitted electronically over a secure network connection to the appropriately credentialed receiving account in the cloud-based medical imaging repository 122, supported on cloud computing servers 112. Accordingly, in various embodiments, such as illustrated in FIG. 3, metadata containing PHI 110 is transmitted to the cloud after the patient or legal representative provides legal consent to transmit said patient's metadata containing PHI 110 in association with their medical imaging studies 109 and metadata not containing PHI 108.

In various embodiments shown in FIG. 3, access to view medical imaging studies 109 together with AM/PHI 108 and AM+PHI 110, is established by electronic permissions exchanged between users of the system by means of interface with the cloud medical image viewing and sharing software 113 from one or more devices with internet access, for instance, laptop computers 114, desktop computers 115, tablet computers 116, smartphones 117, or other internet-enabled appliances, wherein the Patient or Patient's Legal Representative is designated the controlling entity or study owner and exerts control electronically over designation of sharing and viewing permissions.

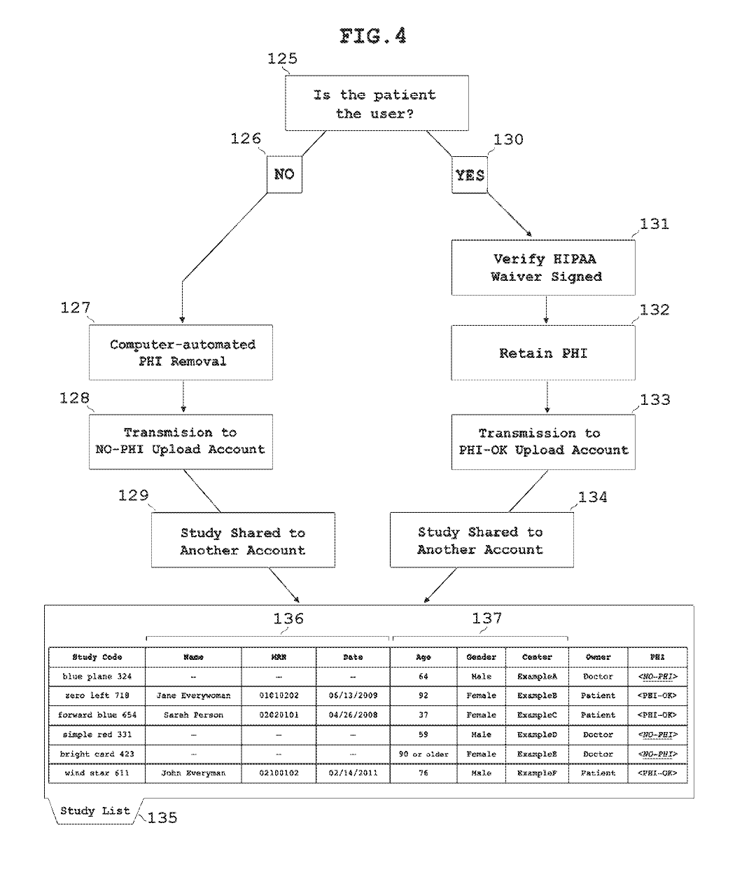

In FIG. 4, the process by which two study types may be shared with a single viewing account in the cloud-based medical image repository is illustrated. The determination of whether the user is the Patient (or the Patient's Legal Representative) 125 is made according to the embodiments illustrated in FIGS. 1-3 and described with reference to those FIGs above.

As shown in FIG. 4, in the circumstance in which the medical images do not belong to the user 126 (for example, the studies belong to the patient of a doctor using the system), computer-automated removal of PHI is performed 127 and then the Cleared Imaging Studies Without PHI are transmitted 128 to an account in the cloud-based medical imaging repository capable and appropriately credentialed to receive studies with AM/PHI but without AM+PHI. The study can then, at the controlling user's discretion, be shared 129 with another account in the cloud-based medical imaging repository.

As shown in FIG. 4, in the circumstance in which the medical images do belong to the user 130 (for example, the user is the Patient represented in the studies or said Patient's Legal Representative), the cloud-based medical imaging system verifies that the appropriate account has an electronically signed permission to retain PHI (for example, a signed HIPAA Waiver 131). PHI is retained 132 and then the Cleared Imaging Studies With PHI are transmitted 133 to an account in the cloud-based medical imaging repository capable and appropriately credentialed to receive studies with associated PHI. The study can then, at the controlling user's discretion, be shared 134 with another account in the cloud-based medical imaging repository.

As shown in FIG. 4, when medical imaging studies of the two types (Cleared Imaging Studies Without PHI and Cleared Imaging Studies With PHI) are shared 129, 134 with another account, the viewer of these studies may easily differentiate the two study types in an electronic Study List 135 by study attributes such as PHI status, Study Owner, and the presence or absence of displayed values in data fields representing AM+PHI 136 (such as Name, Medical Record Number (MRN), and Study Date). In other fields displaying AM/PHI 137, all studies display values.

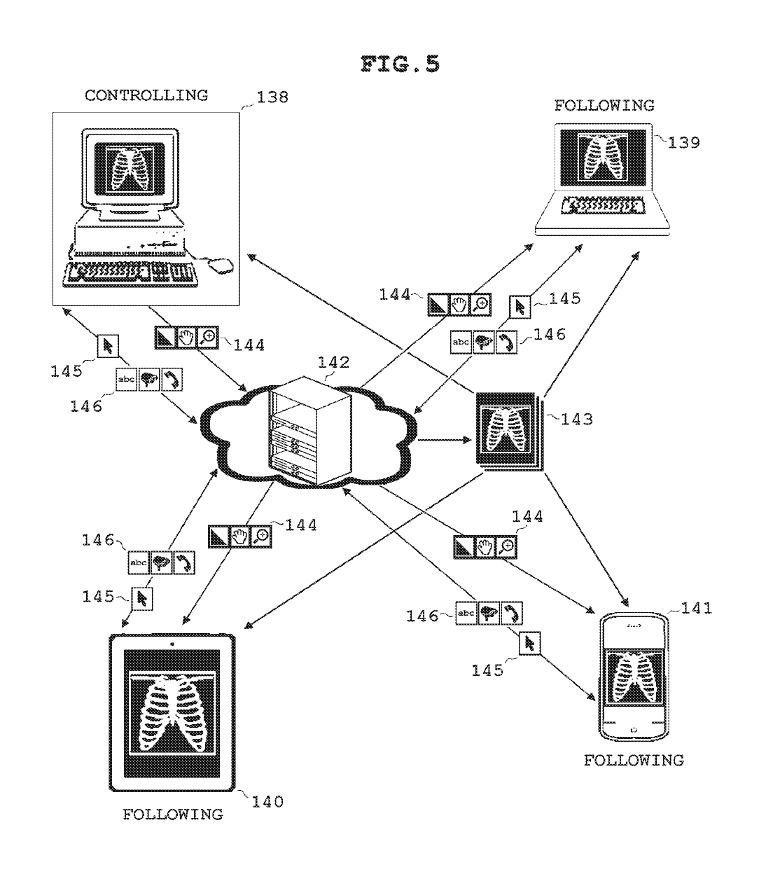

FIG. 5 illustrates various embodiments of the method by which two or more users of network-enabled devices view unaltered medical images at the same time, with exchange of additional data streams to support image viewing. In various embodiments, as illustrated in FIG. 5, several network-enabled devices 138, 139, 140, 141 are shown viewing the same medical imaging study 143 on the cloud-based medical imaging system 142. The medical images 143 are transmitted to each of the connected devices and stored locally on each device, for example, in the cache of a web browser or other application being used to run the cloud-based medical image viewing software and display the medical images. In the embodiment illustrated in FIG. 5, one device 138 is the controlling device and transmits data streams comprising image window width and level, image pan, and image zoom 144 to the cloud-based imaging system 142 and from the cloud based imaging system 142 to the other devices 139, 140, 141. Position of cursors 145 and additional data streams comprising text, video, and audio 146 are shared among the devices 138, 139, 140, 141 by exchanging data with the cloud-based medical imaging system 142. In other embodiments, controlling status is exchanged from one device to another. In other embodiments, multiple devices may have controlling status over one or more additional data streams.

As illustrated in the embodiments in FIG. 5, separation of medical image data and additional data streams provides a method wherein medical images are transmitted to multiple user's devices without alteration of the medical images and adjustments to the local appearance of the medical images are communicated by exchange of additional data without durably altering the medical images.

Other embodiments are within the claims.

What is claimed is:

1. In a computerized device, a method of managing medical image data, the method comprising:
receiving an original medical imaging study that includes a set of medical images and embedded protected patient information;
performing a protected patient information removal operation which generates a cloud-storable medical imaging study from the original medical imaging study, the cloud-storable medical imaging study including the set of medical images but omitting the embedded protected patient information; and
storing the cloud-storable medical imaging study in a cloud-based medical image repository among other cloud-storable medical image studies, the cloud-based medical image repository being external to the computerized device and public network accessible.

2. A method as in claim 1 wherein the original medical imaging study contains a set of original image files, each original image file including (i) image data defining an individual medical image and (ii) header data identifying that individual medical image, the header data including non-protected metadata and protected metadata; and
wherein performing the protected patient information removal operation includes:
forming a set of processed files from the set of original image files, the set of processed files including (i) the image data of each original image file and (ii) the non-protected metadata of the header data of each original image file while omitting the protected metadata of the header data of each original image file.

3. A method as in claim 2 wherein the computerized device resides on a private network; and
wherein storing the cloud-storable medical imaging study in the cloud-based medical image repository includes transmitting the cloud-storable medical imaging study from the computerized device residing on the private network to the cloud-based medical image repository through a public network, the private network being secured from the public network by a firewall, and (i) the image data of each original image file and (ii) the non-protected metadata of the header data of each original image file residing together within the cloud-storable medical imaging study.

4. A method as in claim 3, further comprising:
configuring the cloud-based medical image repository to deliver the cloud-storable medical image studies to viewer-enabled web browsers through the public network.

5. A method as in claim 4 wherein configuring the cloud-based medical image repository includes:
generating a set of unique identifiers, and
arranging the cloud-based medical image repository to share the cloud-storable medical imaging study in an outside consultation session with another computerized device, the cloud-storable medical imaging study being uniquely identified among the other cloud-storable medical image studies via the set of unique identifiers.

6. A method as in claim 5, further comprising:
synchronizing a cursor position of the computerized device with a cursor position of the other computerized device during the outside consultation session.

7. A method as in claim 2 wherein forming the set of processed files from the set of original image files includes:
preserving the image data of each original image file in unaltered form within the set of processed files.

8. A method as in claim 7 wherein preserving the image data of each original image file in unaltered form within the set of processed files includes, for each original image file of the set of original image files, generating a compressed image file that corresponds to that original image file, the compressed image file preserving a respective medical image defined by the original image file in unaltered form while having a smaller file size than that of the original image file.

9. A method as in claim 7 wherein each original image file of the set of original image files is in the Digital Imaging and Communications in Medicine (DICOM) format; and
wherein preserving the image data of each original image file in unaltered form within the set of processed files includes:
for each original image file of the set of original image files, generating a processed image file that corresponds to that original image file, the processed image file including the image data of that original image file and being in a format which is different from the DICOM format, and
creating a table that is linked to each processed image file, the table including the non-protected metadata of the header data of each original image file of the set of original image files.

10. A method as in claim 2, further comprising:
storing another cloud-storable medical imaging study in another cloud-based medical image repository through a public network in response to electronic receipt of a Health Insurance Portability and Accountability Act (HIPAA) waiver, the other cloud-storable medical imaging study including (i) the image data defining the individual medical image and (ii) the non-protected metadata and the protected metadata of the header data identifying that individual medical image, of each original image file of the set of original image files.

11. A computer program product having a non-transitory computer readable medium that stores a set of instructions to manage medical image data; the set of instructions, when carried out by computerized circuitry, causing the computerized circuitry to perform a method of:
receiving an original medical imaging study that includes a set of medical images and embedded protected patient information;
performing a protected patient information removal operation which generates a cloud-storable medical imaging study from the original medical imaging study, the cloud-storable medical imaging study including the set of medical images but omitting the embedded protected patient information; and
storing the cloud-storable medical imaging study among other cloud-storable medical image studies in a cloud-based medical image repository which is (i) external to the computerized circuitry and (ii) public network accessible.

12. A computer program product as in claim 11 wherein the original medical imaging study contains a set of original image files, each original image file including (i) image data defining an individual medical image and (ii) header data identifying that individual medical image, the header data including non-protected metadata and protected metadata; and
wherein performing the protected patient information removal operation includes:
forming a set of processed files from the set of original image files, the set of processed files including (i) the image data of each original image file and (ii) the non-protected metadata of the header data of each original image file while omitting the protected metadata of the header data of each original image file.

13. A computer program product as in claim 12 wherein the computerized device resides on a private network;
wherein storing the cloud-storable medical imaging study in the cloud-based medical image repository includes transmitting the cloud-storable medical imaging study from the computerized device residing on the private network to the cloud-based medical image repository through a public network;
wherein the private network is secured from the public network by a firewall; and
wherein (i) the image data of each original image file and (ii) the non-protected metadata of the header data of each original image file reside together within the cloud-storable medical imaging study.

14. A computer program product as in claim 13 wherein forming the set of processed files from the set of original image files includes:
preserving the image data of each original image file in unaltered form within a respective compressed file of the set of processed files, the respective compressed file having a smaller file size than that of that original image file.

15. A computer program product as in claim 14 wherein the method further comprises:
storing another cloud-storable medical imaging study in another cloud-based medical image repository through the public network in response to electronic receipt of a Health Insurance Portability and Accountability Act (HIPAA) waiver, the other cloud-storable medical imaging study including (i) the image data defining the individual medical image and (ii) the non-protected metadata and the protected metadata of the header data identifying that individual medical image, of each original image file of the set of original image files.

16. An electronic apparatus, comprising:
a communications interface;
memory; and
processing circuitry coupled to the communications interface and the memory, the memory storing instructions that, when carried out by the control circuitry, cause the control circuitry to:
receive an original medical imaging study that includes a set of medical images and embedded protected patient information,
perform a protected patient information removal operation which generates a cloud-storable medical imaging study from the original medical imaging study, the cloud-storable medical imaging study including the set of medical images but omitting the embedded protected patient information, and
store, through the communications interface, the cloud-storable medical imaging study among other cloud-storable medical image studies in a cloud-based medical image repository which is (i) external to the computerized circuitry and (ii) public network accessible.
